(19) United States
(12) Patent Application Publication
(10) Pub. No.: US 2005/0049922 A1
(43) Pub. Date: Mar. 3, 2005

(54) Method and apparatus for specifying toppings and their placement on a pizza and confirming same

(75) Inventor: James B. Kargman, Chicago, IL (US)

Correspondence Address: Howard E. Silverman;GREENBERG TRAURIG LLP, Ste. 2500, 77 W. Wacker Drive, Chicago, IL, 60601, US

(73) Assignee: IPDEV CO., Chicago, IL (US)

(21) Appl. No.: 10/807,783

(22) Filed: Mar. 24, 2004

Related U.S. Application Data
(60) Provisional application No. 60/457,028, filed on Mar. 24, 2003.

(51) Int. Cl. G06F 17/60

(52) U.S. Cl. 705/15

(57) ABSTRACT

A method is disclosed for designating toppings to be assembled on a pizza as well as their respective position on the pizza wherein an order entry terminal is provided for a customer to use to specify an order for a pizza, the terminal being connected to a point-of-sale system and includes a display screen, voice synthesis generator, microphone, speaker, voice recognition processor capable of detecting the customer's spoken words and microprocessor controller. The customer is prompted to enter an order by speaking words in a human voice and in turn an image of the pizza ordered is displayed to permit the customer to confirm the accuracy and submit the order into a point-of-sale system.

### BACKGROUND OF THE INVENTION

1. Field of the Invention

The present invention relates to an improved method and apparatus for ordering food items and in particular a system for designating the ingredients or toppings to be assembled on a pizza as well as their position on the pizza. It is contemplated that the present method and apparatus, including voice recognition functionality, be incorporated into a point of sale order screen based system operating in a retail store setting at the order counter or at a stand-alone kiosk or terminal, as well into a telephone based order taking system.

2. Background and the Prior Art

A pizza parlor operating a carry-out and/or delivery business typically maintains a phone bank staffed by order takers who answer incoming telephone calls from customers who are calling to place an order for pizzas or other food items to be picked-up by the customer or delivered to the customer's location or otherwise wait on customers who arrive and order in person. The order takers receive the caller's order which is ultimately relayed to the kitchen to be filled. In some instances, the order takers merely note the customer's order on a printed order form by handwriting the particular order or by checking off boxes on the preprinted form to designate the food items being ordered. In some cases, order takers may have access to a computer based point-of-sale order system where, using a visual display and/or user input device such as a keyboard or touch-screen, they are able to enter into a computer system both the customer's identifying information, such as a name, address and/or telephone number, as well as the food items being ordered. Such computerized systems operate according to software programming which executes the order entry process and controls the screen display, automatically calculates the total charge for the order and transmits the order automatically to the kitchen for preparation.

One of the challenges in the food service industry is to take a customer's food order quickly and accurately and to efficiently transmit the order to the food preparation area in the kitchen toward ultimate delivery of the product to the customer. In a typical restaurant serving pizza, the customer is provided with the opportunity to select from a list ingredients which particular toppings the customer wants placed on the pizza. Customers are further provided the opportunity to specify that certain toppings be placed on one-half of the pizza and other toppings be placed on the other half. Moreover, customers are typically offered the opportunity to designate not only the particular toppings, but also the quantity of toppings, usually as a multiple of the standard measure, e.g. such as by ordering a pizza with double pepperoni. Customers have become quite creative when it comes to configuring pizza orders. Pizza toppings are no longer limited to the basic ingredients and increasingly include more and more ingredients and toppings, some unconventional, and even exotic. A given customer may place a relatively complex order in an attempt to meet the demands of all of the members of a family who are sharing the pizza. The typical prior art order entry system, be it paper or computerized, still presents a significant opportunity for error in the order taking process—errors which are typically not discovered until a customer receives delivery or returns home with a carry-out order. Errors in the order taking process can cost a restaurant both money and good will in having to replace incorrect orders and/or provide credits to be used on future purchases. Staffing, wait times, language barriers can all generate errors and lead to customer dissatisfaction.

The present invention provides a unique and useful method and apparatus for use in conjunction with a computerized point of sale system which facilitates the taking of standard and custom orders from customers specifically designating ingredients or toppings for the left side, right side or entire pizza all in a intuitive and graphic fashion.

The present invention, as will be shown, serves to eliminate the difficulties presented by the conventional order taking methods, and provides a means to assure that pizzas, and other foods that consist of multiple options, are prepared correctly and consistently.

One embodiment of the present invention further serves to permit the order taker and/or the customer to not only easily enter an order but to also easily verify the correctness of the order by viewing in color a display indicating the pizza toppings chosen, confirming the customer's order and minimizing error.

The present invention additionally serves to permit the user or customer to speak into a voice recognition based system allowing the order taker or customer to audibly interact with the system to place an order and select desired ingredients and their placement on a pizza.

In another embodiment of the present invention the system generates and presents to the user a photo-realistic image of the finished pizza including the selected ingredients whereby the customer can see the final product at the time the order is being placed to catch errors, prevent mistakes and further improve customer satisfaction. In the context of the retail store environment, the present invention may be used both by store employees serving customers placing orders by phone or in person, as well as customers themselves at self-service kiosks or stand-alone terminals. In addition, the present invention may be used by customers who place a food order via telephone or via an on-line or web based order entry system.

These and other desirable characteristics of the present invention will become apparent in view of the present specification and drawings.

### SUMMARY OF THE INVENTION

A method is disclosed for designating toppings to be assembled on a pizza as well as their respective position on the pizza utilizing a user interface having a plurality of three part “buttons” where each button is associated with a specific topping which the customer may choose to have applied to a pizza. The three parts of each button correspond to the left half, right half and entire surface of the pizza respectively. The method of one embodiment of the present invention comprises the steps of: selecting one part of one of the three part buttons to designate the application of the topping associated with the button pressed to the left half, right half, or entire surface of the pizza; highlighting at least a portion of the left half, right half or entirety of the button pressed to indicate that the left half, right half or entire surface of the pizza is to receive the topping associated with the button pressed; and repeating the foregoing steps for each topping to be designated for application to the pizza.

The step of selecting a part of one of the three part buttons may be performed by touching the button, where the buttons are displayed on an electronic touch screen video display. Alternatively the step of selecting one part of one of the three part buttons may be performed by pressing one or more keys on a computer keyboard that are associated with the button part being selected, in lieu of the use of a touch screen based system.

The user may press one or more keys on a computer keyboard by simultaneously pressing a first key and a second key, where the first key is associated with a particular topping and the second key is associated with the portion of the pizza (left, right or all) to which the topping should be applied. In a further embodiment, the buttons may be comprised of regions on an electronic video display, and the step of selecting one part of one of the three part buttons may comprised of the substeps of positioning a cursor on the video display over the button part to be selected using an electronic pointing device; and performing a clicking operation with the electronic pointing device.

A further embodiment of the present invention comprises the steps of: selecting a first part of one of the three part buttons to designate the application of the topping associated with the button pressed to the portion of the pizza surface corresponding to the first part; highlighting a first portion of the left half, right half or entirety of the button pressed to indicate that the left half, right half or entire surface of the pizza is to receive the topping associated with the button pressed; selecting the first part of one of the three part buttons a second time to designate that a double portion of the topping is to be applied to the portion of the pizza surface corresponding to the first part; highlighting a second portion of the left half, right half or entirety of the button pressed to indicate that the left half, right half or entire surface of the pizza is to receive a double portion of the topping designated; and repeating the foregoing steps for each topping to be designated for application to the pizza.

The present invention also comprises a graphic user interface apparatus for facilitating the designation of toppings to be assembled on a pizza as well as their respective positions on the pizza. The user interface comprises a plurality of buttons each corresponding to a specific topping which may be designated for application to a pizza. Each button has a left, center and right region corresponding respectively to the left half, entire surface and right half of the pizza. Means, such as software operating on the computerized point of sale system control the display screen and highlight at least a portion of the left half, right half or entirety of each button when the left, right or center region of a button is selected; whereby the topping associated with each button is to be applied to the portion of the pizza corresponding to the highlighted regions. The graphic user interface may further provide for highlighting a first portion of the left half, right half or entirety of each button when a left, right or center region of the button is selected a first time; and highlighting a second portion of the left half, right half or entirety of each button when the left, right or center region of the button is selected a second time; whereby the topping associated with each button is to be applied to the portion of the pizza corresponding to the highlighted regions in a quantity corresponding to the number of highlighted portions of each region.

### BRIEF DESCRIPTION OF THE DRAWINGS

FIG. 1 of the drawings illustrates one example of an in-store self service terminal or kiosk according to the present invention,

FIG. 1a of the drawings illustrates the main functional components of the self service terminal or kiosk according to the present invention, FIG. 2 of the drawings illustrates the use of a multicolor graphical user interface according to the present invention for specifying ingredient selection and placement on a pizza, and

FIG. 3 of the drawings illustrates detailed examples of the visual appearances of a single topping “button” as displayed according to the present invention.

### DETAILED DESCRIPTION OF THE DRAWINGS

While this invention is susceptible to embodiment in many different forms, there are shown in the drawings and will be described in detail herein several specific embodiments. The present disclosure is to be considered as an exemplification of the principle of the invention intended merely to explain and illustrate the invention, and is not intended to limit the invention in any way to embodiments illustrated.

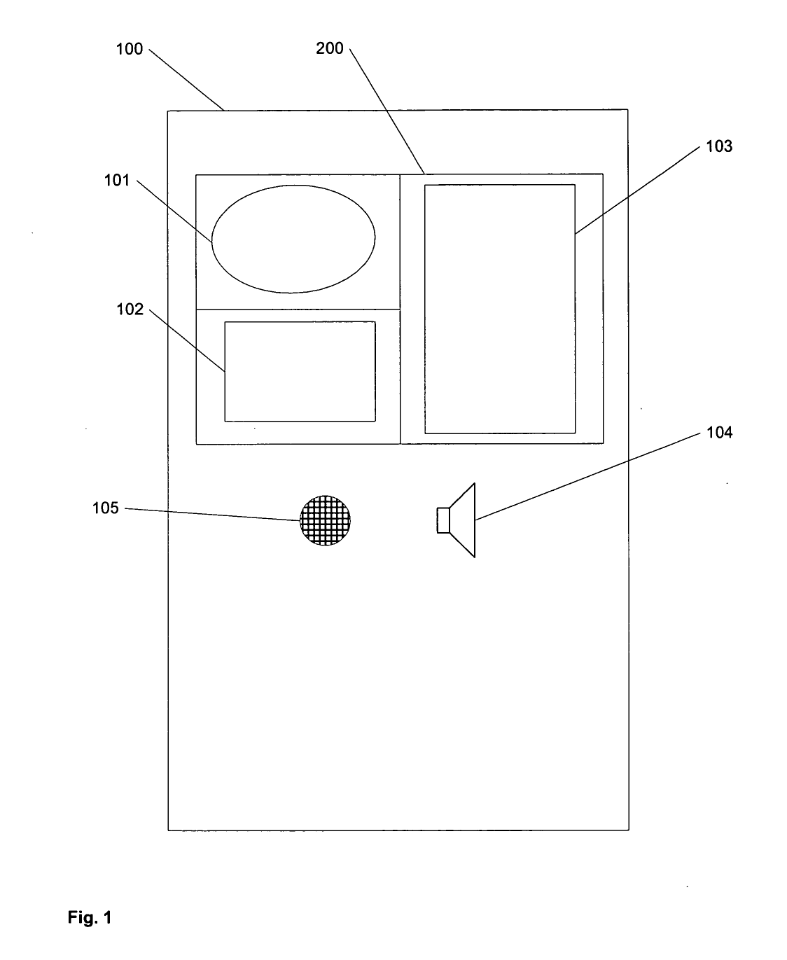

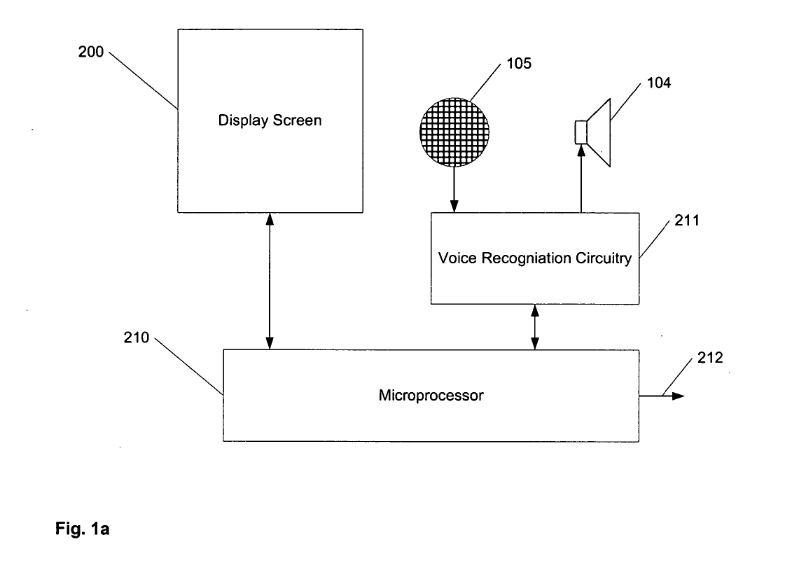

FIG. 1 of the drawings illustrates one embodiment of the present invention and specifically illustrates an in-store self-serve kiosk or terminal which permits a customer to place an order of a pizza or other food product. Kiosk or terminal 100 is shown including display screen 200. In the embodiment illustrated, display screen 200 includes three distinct display areas, each of which display different content to the user or customer. Display area 101 is the region of display screen 200 which displays a photo-realistic image of the pizza or food item ordered by the customer. Display area 102 is the region of display screen 200 which displays a multi-color graphical user interface which may include a plurality of “buttons” which the user may press by physically contacting the screen proximate the button in the case of a touch-screen display, or by pointing and clicking with cursor control device, or by using the keyboard and pressing the key associated with a particular button. Display area 103 is the region of display screen which serves to present the user with optional information such as menu items, descriptions, advertised or unadvertised special offers etc. Though preferred, display area 103 optionally may be omitted and replaced by a printed menu board upon which appears the items offered by the restaurant.

Microphone 105 is provided for detecting the customer's spoken voice as further described below. Speaker 104 is provided for presenting audio communication or output to the customer. Optionally, microphone 105 and speaker 104 can be embodied in a telephone style handset.

FIG. 1a of the drawings illustrates the main functional blocks or components of the terminal or kiosk according to the present invention. Display screen 200 is connected to microprocessor 210. As described herein, display screen 200 may comprise a touch-screen enabled display device. Speaker 104 and microphone 105 are illustrated as connected to a voice recognition processor 211 which is in turn connected to microprocessor 210. Microprocessor 210 is connected to a point-of-sale order processing system (not shown) via connection 212. Connection 212 may be either hardwired or wireless.

In operation, the user or customer approaches the kiosk or terminal to place an order for pizza and/or other food items. The user speaks to the system using microphone 105. Microphone 105 may comprise a unidirectional microphone to minimize interference or may be integrated into an conventional telephone handset. The voice recognition processor accepts and reacts to the spoken commands of the consumer who audibly specifies the ingredients and their placement on a pizza. The system may initiate the order taking session by issuing a series of audible prompts or questions to the user to respond to in turn. For example, the system may initially audibly ask the user what size pizza the customer wishes to order. The system may optionally offer choices from which the user can select, by announcing the possible choice, e.g., small, medium and large. The system then detects the users response. This same interactive protocol may be used for the balance of the order taking session by querying the customer as to each of the possible options, including but not limited to pizza type, ingredients, portions, placement, and other variables. One of various known proximity detection devices may be included in the kiosk whereby the presence of a customer is detected toward initiating the customer order process and triggering an initial greeting or prompt from the kiosk.

In an alternative embodiment, the system may simply “listen” to the customer speak an entire order in narrative fashion toward the system then analyzing the complete narrative input toward ascertaining the order particulars.

The present system further includes language recognition as a component of the voice recognition processor. A terminal will typically be programmed to a default language, such as English. If a customer approaches the terminal and begins to speak another language, such as Spanish, to place an order the system will detect that Spanish is being spoken. In response, any audible reply to the customer will be spoken by the system in Spanish. Further, the text of any visual displays presented on display screen 200 will change from English to Spanish. If for some reason the automatic language detection does not function, the display screen can include a “language” icon or button which permits manual selection of the language.

In response to the user's spoken responses or instructions, the system will configure the customer's order for a pizza. In turn, the system will display a photo-realistic image of the pizza being ordered in display region 101. In this manner the user can visually confirm the order and detect a user or system error and modify the order. The nature of the displayed pizza can vary. In one embodiment the displayed photo-realistic image may be that of a finished cooked pizza having the ingredients and locations as specified by the customer. In another embodiment, the displayed image may comprise a series of images depicting the pizza being “built-up” ingredient by ingredient as specified by the customer. In yet another embodiment, the display region 101 may display an animated or real-life moving picture depicting the pizza ordered by the customer.

As an example, a customer may order a large pizza with cheese and pepperoni toppings. In response the system will cause an image of cooked cheese and pepperoni pizza to appear on the screen. The system can cause only the complete finished pizza to be displayed, or alternatively, it can show the pizza being assembled. In the later case the pizza is “built-up” step by step or ingredient by ingredient, as they are specified by the customer and entered into the system by the order taker. Ingredients can be shown as appearing on the whole or either half of the pizza. The customer can thereby readily see with their own eyes the finished pizza and can verify that it meets with their expectations and/or that it conforms to what the customer indeed ordered. Order taker mistakes, or customer mistakes can be caught and orders corrected before being passed on to the kitchen for preparation.

The actual generation of the displayed images of a finished pizza can be accomplished through a variety of techniques and technologies. In a most direct fashion, a discrete photo-realistic image of a finished pizza is displayed. The system accordingly has in its electronic storage an inventory of images corresponding to each of the multitude of possible order combinations. Alternatively, a display layer technique can be employed where the graphical image is built up layer by layer. In such a system, transparent layers can be used to cause images layer to appear. Semi-transparent layers can also be used to add effect to the displayed image. In either case, the image of the finished pizza appears right before the customer's eyes.

The foregoing use of a display at a customer order station provides great benefit to both the customer and the restaurant by providing a mechanism for catching mistakes and minimizing waste and whereby customer satisfaction is enhanced.

Display region 103 will further, in turn, be populated with a graphical user interface comprise a series of icons or buttons, as further illustrated in FIG. 2 where the various “buttons” are highlighted to correspond to the spoken order as detected by the system. The system may thus offer the customer the ability to modify the order by either renewing the audible interactive voice recognition session or alternatively using the graphical user interface. When satisfied that the order is complete and accurate the customer may submit the order by spoken voice in response to a system generated prompt, or for security purposes, by pressing a soft key presented to the user on display screen 200.

As referred to above, the present system generally comprises a display monitor positioned at an order taking kiosk or terminal within the pizza restaurant. Alternatively, the system may be incorporated into a point of sale display located at the traditional order counter within a restaurant. The system may be used solely by the customer, or alternatively, may be used by a store employee. In such a system, to avoid miscommunications between the customer and the order taker, and to further enhance the sales experience, a display monitor is positioned so as to be viewable by the customer during the order placement process.

If multiple pizzas are ordered, they can be displayed sequentially to the customer as part of the order taking process.

FIG. 2 of the drawings illustrates one embodiment of the present invention and specifically illustrates a multicolor graphical user interface according to the present invention for use in specifying ingredient selection and placement on a pizza. The graphical user interface 20 pictured in FIG. 2 is contemplated as being presented to a system user or order taker on a CRT or touch-screen terminal. The graphical user interface 20 includes and presents to the user a plurality of “buttons” which the user may press by either positioning a cursor over the button using a mouse and clicking, by physically contacting the screen proximate the button in the case of a touch-screen display, or by using the keyboard and pressing the key associated with a particular button. The generation of the display is under the control and operation of the computerized point of sale system running software programming which can be readily created by one of ordinary skill in the art having the present disclosure before them.

The displayed screen of a first embodiment, which is identified as “screen No. 1” in the upper left corner, illustrates several fields, each conveying information relevant to the business and/or individual transaction being conducted. Specifically, region 1 identifies the name and telephone number of the customer calling the restaurant. Within this region, the employee number of the user operating the terminal, as well as the restaurant's store number are identified together with a synopsis of the last order placed by this customer. Region 2 of the screen conveys to the user parameters relative to the current order including the time of day and the total amount due from the customer based upon the order for food items being placed.

Region 3 specifies in text format the particular food items which the user has entered into the system corresponding to food items being ordered by the customer. In the present illustration, a single item is pictured as having been ordered and as identified by the indication “01” in the left most column of region 3 and identifies that a single item under the column heading quantity (QTY) has been ordered and identifies that the item is a large sized pizza as indicated by the abbreviations LTH.

Columns labeled “side 1” and “side 2” serve to provide a textual indication to the user that side 1 of the pizza is to contain a double pepperoni topping (as represented by two “P's”) and a single sausage topping (as represented by a single “S”) and that side 2 is to contain only a double pepperoni topping (as represented by two “P's”). The “comments” field in the embodiment illustrated informs the kitchen that the pizza is not to be cut and further that extra parmesan cheese is to be added. If additional food items were ordered they would appear in region 3, one after the other in rows “02”, “03” and so forth. The arrows shown in region 4 permit scrolling this display up and down to permit the user to view and, if necessary, edit line items corresponding to the food items ordered.

In this particular screen, the pizza button has been selected, indicated by its being highlighted or changing to a different color. By selecting the “pizza” button the ingredient menu for pizzas is displayed in region 6. Customer orders for other food items may be entered selecting one of the remaining buttons associated with “subs”, “drinks” or other “items” displayed in region 5. Access to additional system options, entry of notes or adjustments may be obtained by pressing buttons 7 through 9, respectively. The order screen can be cleared by actuating button 10. An order summary may be obtained with button 11 and the order can be designated as accepted for processing by pressing button 12. Additional price information and customer information can also be obtained using buttons 13 and 14.

The graphics displayed in region 6 illustrate a novel aspect of the present invention which provides a user interface and implements a novel method for designating the toppings and ingredients to be applied to a pizza in a graphical manner facilitating the order entry verification in a very intuitive and insightful manner.

The illustrated embodiment of the invention provides for selection of fifteen possible toppings using buttons designated A through O. Additional toppings may be selected and their choices presented upon pressing button 15 which will cause further ingredient buttons to be displayed, taking the place of buttons A-O. The most recent action taken by the order taker can be erased by pressing “undo” button 16 without clearing the customer's entire order.

Each button A through O appearing on the user interface comprises a combined input means and display element.

In the example illustrated, the user interface display indicates that a single pizza has been ordered, that a double application of pepperoni topping is to be applied to both the left and right side of the pizza and that a single application of sausage topping is to be applied to only the left side of the pizza. The user selects these ingredients for the pizza and views the resulting selection all through the unique graphical user interface presented by the present invention as follows.

To select a topping for the pizza the user merely presses a topping button A-O. Each topping button A through O is divided into three (3) regions, left, center and right which correspond to the left side, all, and right side of the pizza, respectively. By pressing the left region of a button, the ingredient corresponding to that button is selected for application to only the left side of the pizza. If the right region of the button is pressed, that ingredient is selected for application to only the right side of the pizza. If the center region of the button is pressed, that ingredient is selected for application to the entire pizza.

In this manner, the user may accurately input a customer's highly customized order with minimal chance of error by merely pressing the buttons on the touch-screen and designating the whole pizza, or one or the other half of the pizza for receipt of a given topping in a highly intuitive manner.

The button effects described herein can be achieved and implemented by either changes of color or highlighting both of which serve to graphically convey to the user the state of customer's specific order.

The foregoing user interface display may be provided to the customer in whole or in part, depending upon the circumstances and needs of the particular retail store and customer base.

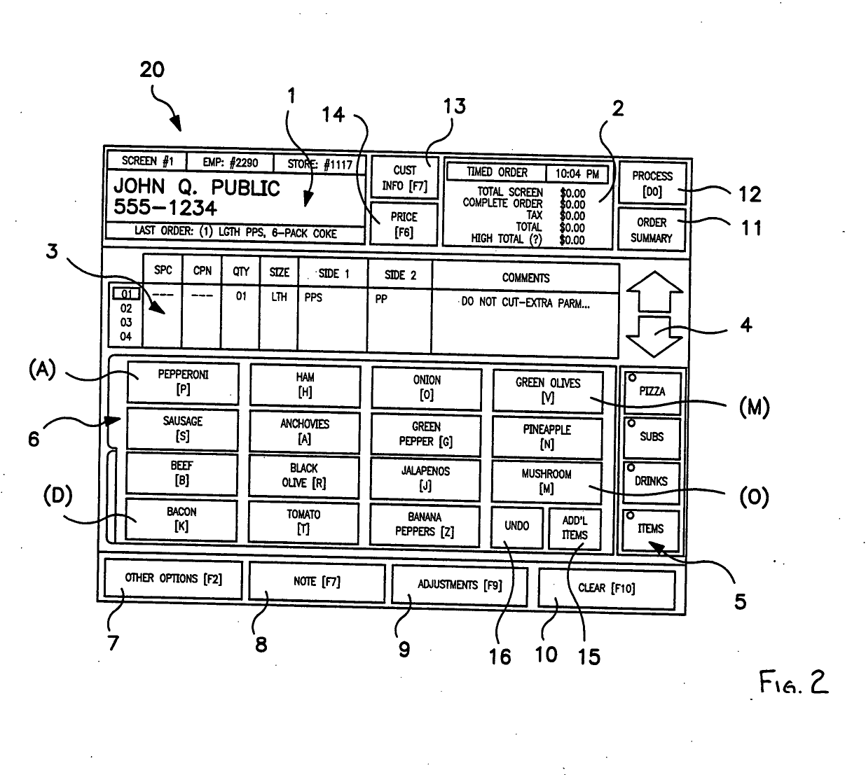

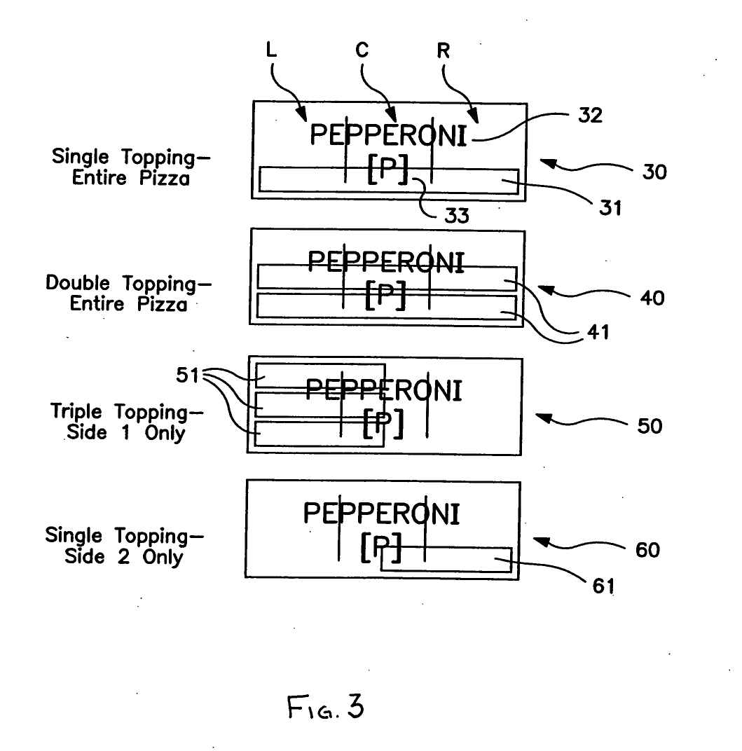

FIG. 3 of the drawings illustrates various detailed examples of the visual appearances of an exemplar topping “button” as displayed in region 6 according to the present invention. The uppermost button 30 illustrated in FIG. 3 corresponds to button A of FIG. 2. However, in the illustrated embodiment, the single colored or highlighted bar 31 of button 30 indicates that a single topping of pepperoni has been designated for application across the entire pizza. Button 30 includes the textual display 32 indicating to the user that this button is applicable to the topping “pepperoni”. The abbreviation “P” appearing in brackets, designated by numeral 33, conveys to the user the shorthand or abbreviation for this button which appears in the textual display of region 3. To select a pepperoni topping for application across the entire pizza the user would merely depress the center region C of button 30 a single time.

Button 40 illustrates that a double topping of pepperoni has been designated for application across the entire pizza. To make this selection the user merely depresses the center region of the button, designation C, two times to signify that a double topping is to be applied across the entire pizza. The double colored or highlighted bars 41 extending across the entire button indicate to the user that a double application of the particular topping has been selected. Button 50 illustrates that a triple application of pepperoni has been designated for application to only the left side of the pizza. This is graphically displayed by showing not one, not two, but rather three colored bars or regions 51 appearing on the left side of the display of button 50. To make such a designation, the user merely presses the left region of button 50, designated “L”, three times.

If the user makes a mistake in designating the quantity of toppings, such as by pressing the any region of a button one or more times too many, the user may simply keep pressing the button and the system will “roll” through the possible designations for that ingredient by showing single, double or triple or no toppings corresponding to that button as being selected.

Button 60 likewise illustrates another example wherein a single order for the ingredient pepperoni has been designated for application to the right side of the pizza only as indicated by the single colored or highlighted bar 61 extending across only the right side of the button. This is likewise accomplished by merely depressing the right region “R” of button 60 a single time.

While most prior art systems that are computer based provide the user with the ability to designate ingredients being applied to only half of the pizza, they do so by providing a “one-half key” or a “left” or “right” key to allow the user to designate which half of the pizza is to receive a topping. However, the present invention is markedly distinct from the foregoing prior examples by providing three separate touch areas on a single on-screen “button” designated left, center and right or alternatively, left, all and right.

Accordingly, if the user touched the center or “all” region of a button, the corresponding ingredient is designated as being applied to the entire pizza and one “bar” across the entire key illuminates or becomes highlighted with a distinct color. If the user touches only the left side of the button, then that particular ingredient is designated as being applied only to the left side of the pizza and one bar across only the left half of the key appears. Conversely, if the user presses the right side of the button, then the ingredient is designated as being applied to only the right side of the pizza and a single bar on only the right half of the button appears. To designate “extra toppings”, the user merely touches the button region again and two bars of intensity would be displayed to designate that a double topping has been selected and if touched again, three bars would be displayed to designate that a triple topping has been selected.

Accordingly, the present invention replaces prior art systems which require that multiple keys be pressed and provides a single unitary display that readily and rapidly communicates to the user in a very clear fashion the particular ingredients or toppings to be applied to the pizza.

In the foregoing examples, it has been contemplated that the present invention be implemented in a computerized system having a touch-screen display element whereby the user merely presses a finger or pencil or other implement upon the surface of the screen proximate and overlying a particular button and region thereof to provide a user input to the system and to thereby actuate that button.

Alternatively, the display could be actuated by user input provided through the use of a conventional keyboard provided as part of the kiosk or terminal where, for example the designation of pepperoni would be made by pressing the key corresponding to the abbreviation appearing below the text indication of pepperoni, e.g. the letter P, sausage the letter S, beef the letter B, etc. By holding down or pressing the key P with another predetermined key, the combined input could be taken to indicate that pepperoni is to be applied to one-half, the other half or all of the pizza, depending upon which additional key is pressed. For example, holding down the letters P and L together on a keyboard could designate that pepperoni is to be applied to the left half of the pizza, and pressing them a second time would indicate double topping on the left half of the pizza. Pressing the letter P together with the letter A could be taken by the system to be designated as applying pepperoni to the entirety of the pizza and so on.

When one of the aforementioned regions within a button is selected or “pressed” via either direct physical contact or keyboard actuation, the visual appearance of the particular button is changed by the addition of graphic highlighting. Accordingly, by merely looking at the graphical user interface, and in particular the topping buttons displayed in region 6, the user can readily and visually observe that the pizza being ordered is to have a double topping of pepperoni across both the left and right side and that only a single application of sausage is being applied to the left side. This is in marked contrast to the textual display shown in region 3, and employed by the prior art. Accordingly, the order taker communicating with the customer is provided with a graphical system which is readily available, discernable, is not subject to misinterpretation, permits the rapid review of the order with the customer and minimizes error in the order taking process.

The present invention could of course be implemented with a conventional non-touch screen display where user inputs are provided to the system by actuation of a keyboard alone and/or in combination with a pointing device such as a computer mouse or roller-ball input device. In such an implementation, buttons such as those of region 6 could be activated through the positioning of the mouse pointer in conjunction with clicking on the left, center, or right portions of a button display.

In another alternative embodiment, the present invention could be implemented in a conventional mechanical or membrane keyboard input device having back-lit keys which are depressed by the user to designate the ingredients or toppings and their placement on a pizza. Depending upon which portion of which key is pressed a corresponding back-light would illuminate to simulate the information provided by the on-screen graphic user interface described above.

Another embodiment of the present method and apparatus provides the user with the ability to place an order for pizza or other food items using a telephone from a remote location, instead of standing before a kiosk or terminal. An interactive or narrative mode of the voice recognition processor can be used to accept and confirm a customer's order where such processor is maintained at a location operated by the restaurant and/or as part of the order entry-processing system.

The present invention may further be incorporated into a drive up window order environment where, again, the customer may speak into a microphone to place an order for food. In response to the order as detected by the voice recognition processor, a video terminal at a drive up station presents the customer with a video display depicting the items ordered thereby permitting the customer to confirm or modify same.

While the present invention is disclosed herein for use in connection with a computerized point of sale system, as discussed herein, this method and apparatus may also be used in connection with Internet based food ordering systems accessed by consumers via the Internet to configure and place their own food orders. Using Java script or enhanced html or active-X programming buttons can be provided to the user which function in the same fashion as they do on a point of sale system. Specifically, the present invention may be implemented in an embodiment whereby the customer communicates with the restaurant, and specifically its order processing system, via a internet connection using a personal computer. The customer's computer monitor may display an internet browser session which mimics display 200 and whereby user input is provided via either a microphone connected to the customer's personal computer, or via the customer's computer keyboard.

While various concepts have been described in detail, it will be appreciated by those skilled in the art that various modifications and alternatives to those concepts could be developed in light of the overall teachings of the disclosure. As such, the particular concepts disclosed are meant to be illustrative only and not limiting as to the scope of the invention which is to be given the full breadth of the appended claims and any equivalents thereof.

1. A method for designating toppings to be assembled on a pizza as well as their respective position on the pizza, the method comprising the steps of:
providing an order entry terminal for a customer to use to specify an order for a pizza, the terminal being connected to a point-of-sale system and including a display screen, voice synthesis generator, microphone, speaker, voice recognition processor capable of detecting the customer's spoken words and microprocessor controller;
prompting the customer to enter an order by speaking words in a human voice;
detecting the customer's spoken words;
displaying a photo-realistic image of a pizza according to the order specified by the customer;
displaying a graphical user interface to permit the customer to manually alter the order;
confirming the accuracy of the customer's order; and
entering the customer's order into the point-of-sale system.

2. The invention according to claim 1 wherein the method further includes the step of detecting the customer's initiation of the order entry process and responding by presenting a spoken greeting to a customer in synthesized human speech.

3. The invention according to claim 1 wherein the step of prompting the customer to enter an order for a pizza comprises the step prompting the user to enter their order by speaking in a narrative fashion.

4. The invention according to claim 3 wherein the step of detecting the customer's spoken words comprises the step of analyzing the customer's spoken narrative toward identifying the particular food order being placed.

5. The invention according to claim 1 wherein the step of prompting the customer to enter an order for a pizza comprises the step presenting a series of two or more individual prompts to the customer soliciting the user to enter an order by responding to individual prompts presented one at a time to the customer.

6. The invention according to claim 5 wherein the step of detecting the customer's spoken words comprises the step of analyzing each of the customer's spoken responses provided in response to the individual prompts toward identifying the particular food order being placed.

7. The invention according to claim 5 wherein the step of prompting the user comprises generating and presenting to the user words in a synthesized human voice.

8. The invention according to claim 1 wherein the step of detecting the customer's spoken words further includes the step of automatically identifying the language spoken by the customer toward generating further prompts to the customer in the same language spoken by the customer.

9. The invention according to claim 1 wherein the method further includes the step of providing the customer the ability to identify a preferred language to be spoken to the customer.

10. The invention according to claim 1 wherein the step of displaying a photo-realistic image of a pizza according to the order specified by the customer comprises the step of displaying a static image of a cooked pizza.

11. The invention according to claim 1 wherein the step of displaying a photo-realistic image of a pizza according to the order specified by the customer comprises the step of displaying an animation which illustrates the preparation of the pizza by the addition of each raw ingredient called for by the customer's order.

12. The invention according to claim 1 wherein the method further includes the step of displaying to the customer a user interface which includes a menu identifying various food items available for order by the customer.

13. The invention according to claim 1 wherein the order entry terminal is located within a restaurant.

14. The invention according to claim 1 wherein the order entry terminal comprises a customer's personal computer located remote to a restaurant and which is in turn connected to the point-of-sale system via an Internet connection.

15. The invention according to claim 1 wherein the order entry terminal is provided at a drive through location operated by a restaurant whereby a customer may place an order from a motor vehicle.

16. A method for designating toppings to be assembled on a pizza as well as their respective position on the pizza, the method comprising the steps of:
providing an order entry terminal for a customer to use to specify an order for a pizza, the terminal being connected to a point-of-sale system and including a display screen, voice synthesis generator, microphone, speaker, voice recognition processor capable of detecting the customer's spoken words and microprocessor controller;
prompting the customer to enter an order using spoken words;
detecting the customer's spoken words in actual human speech;
providing a video display viewable by the customer capable of displaying a photo-realistic image of a pizza according to the order specified by the customer, a graphical user interface permitting the customer to manually alter an order; and capable of displaying a menu of food items available for order;
accepting confirmation of the accuracy of the customer's order;
and entering the customer's order into the point-of-sale system.

17. A method for ordering food items, the method comprising the steps of:
providing an order entry terminal for a customer to use to specify an order for one or more food items, the terminal being connected to a point-of-sale system and including a display screen, voice synthesis generator, microphone, speaker, voice recognition processor capable of detecting the customer's spoken words and microprocessor controller;
prompting the customer to enter an order by speaking words in a normal human voice;
identifying each food item ordered by the customer by detecting the customer's spoken words;
displaying a photo-realistic image of each food item according to the order specified by the customer;
displaying a graphical user interface to permit the customer to manually alter the order;
confirming the accuracy of the customer's order; and
entering the customer's order into the point-of-sale system.

18. An order entry terminal for use with an computerized point-of-sale order processing system for permitting a customer to order a pizza by designating the toppings to be assembled on a pizza as well as their respective position on the pizza, the order entry terminal comprising:
a microprocessor based controller including a voice synthesis generator for presenting audible sounds in synthesized human speech;
a touch screen video display;
an audio speaker;
a voice recognition processor connected to the controller;
a microphone;
a power supply; and
a communication circuit for connecting the terminal to computerized point-of-sale order processing system;
whereby a user may define an order for a pizza by speaking in a normal human voice which is recognized by the terminal which in turn causes a visual image of the pizza detected as being ordered to be displayed to the customer toward the customer confirming and submitting the order into a point-of-sale system.
